(19) United States
(12) Patent Application Publication
(10) Pub. No.: US 2025/0306355 A1
(43) Pub. Date: Oct. 2, 2025

(54) METHOD OF CALIBRATING A MICROSCOPE SYSTEM

(71) Applicants: Jung-Chi LIAO, Taipei City (TW); SYNCELL (TAIWAN) INC., Taipei City (TW)

(72) Inventors: Jung-Chi LIAO, Taipei City (TW); Yi-De CHEN, Taipei (TW)

(21) Appl. No.: 18/864,988

(22) PCT Filed: May 12, 2023
(86) PCT No.: PCT/US2023/066944

§ 371 Date: Nov. 12, 2024

Related U.S. Application Data
(60) Provisional application No. 63/341,244, filed on May 12, 2022.

(51) Int. Cl. G02B 21/36; G01N 15/10; G01N 15/14; G01N 15/1433; G02B 21/06

(52) U.S. Cl. CPC G02B 21/365; G01N 15/1012; G01N 15/1425; G01N 15/1433; G02B 21/06; G01N 2015/1006

(57) ABSTRACT

A microscope based system for image-guided microscopic illumination is provided. The system may include a microscope, a stage, an imaging subsystem adapted to obtain an image of a sample on the stage, a processing subsystem adapted to identify regions of interest in the sample from images obtained by the imaging subsystem, and a pattern illumination subsystem adapted to illuminate the regions of interest based on coordinates derived from the images by the processing subsystem. Methods of calibrating the microscope based system may include projecting light from the pattern illumination subsystem in an intended pattern according to a plurality of coordinates corresponding to locations on the sample, measuring differences between coordinates of locations where the light strikes the sample and coordinates of the intended pattern, and generating correction factors based on the measured differences from the steady states and dynamic states.

### CLAIM OF PRIORITY

This application claims priority to U.S. Provisional Patent Application No. 63/341,244 filed on May 12, 2022, titled “METHOD OF CALIBRATING A MICROSCOPE SYSTEM,” which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

### Technical Field

The present disclosure relates to a system and method for illuminating patterns on a sample, especially relating to a microscope-based system and method for illuminating varying patterns through a large number of fields of view consecutively at a high speed. The present disclosure also relates to systems and methods for calibrating a microscope-based system.

### Related Arts

There are needs in illuminating patterns on samples (e.g., biological samples) at specific locations. Processes such as photobleaching of molecules at certain subcellular areas, photoactivation of fluorophores at a confined location, optogenetics, light-triggered release of reactive oxygen species within a designated organelle, or photoinduced labeling of biomolecules in a defined structure feature of a cell all require pattern illumination. For certain applications, the pattern of the abovementioned processes may need to be determined by a microscopic image.

Some applications further need to process sufficient samples, adding the high-content requirement to repeat the processes in multiple regions. Systems capable of performing such automated image-based localized photo-triggered processes are rare.

One example of processing proteins, lipids, or nucleic acids is to label them for isolation and identification. The labeled proteins, lipids, or nucleic acids can be isolated and identified using other systems such as a mass spectrometer or a sequencer.

Complicated microscope-based systems can include a number of subsystems, including illumination subsystems and imaging subsystems. Minor mismatches between the various subsystems of a microscope-based system can result in a mismatch between imaging samples, detecting the patterns, and the pattern illumination. Besides, varying patterns for the illumination requires different scanning path and corresponding dynamic control. Due to the various mechatronics response and behavior, different dynamic control can cause a mismatch between the detected patterns and the results of the pattern illumination. Therefore, there is a need for calibration techniques to ensure that microscope-based systems are able to accurately illuminate varying patterns on the microscope samples through a large number of fields of view consecutively at a high speed.

### SUMMARY

In view of the foregoing objectives, this disclosure provides image-guided systems and methods to enable illuminating varying patterns on the sample and calibration of the image-guided systems to ensure accurate illumination of patterns on the sample.

A method of calibrating a microscope system, the microscope system comprising a stage, an imaging subsystem adapted to obtain an image of a sample on the stage, a processing subsystem adapted to identify regions of interest in the sample from images obtained by the imaging subsystem, and a pattern illumination subsystem adapted to illuminate the regions of interest based on coordinates derived from the images by the processing subsystem, the method comprising: projecting light from the pattern illumination subsystem in an intended pattern according to a plurality of coordinates corresponding to locations on the sample; measuring differences between coordinates of locations where the light strikes the sample and coordinates of the intended pattern; and generating correction factors based on the measured differences.

In some aspects, the sample is a fluorescent sample. In other aspects, the sample is a reflective sample. In some aspects, the sample is able to be photo-marked.

In one aspect, the step of measuring differences comprises observing the sample with the imaging subsystem while the pattern illumination subsystem projects light on the sample.

In some aspects, the method comprises storing the correction factors.

In one aspect, the method comprises using the correction factors to adjust a position of light projected by the pattern illumination subsystem for calibrating the projected light in real-time in various fields of view.

In one aspect, the pattern illumination subsystem comprises a movable element.

In another aspect, the step of using the correction factors to adjust a position of light projected by the pattern illumination subsystem comprises adjusting movement of the movable element. In some aspects, the projecting step comprising moving the movable element to project light from the pattern illumination system sequentially from a first coordinate to a second coordinate and from the first coordinate to a third coordinate, a distance between the first coordinate and the second coordinate being different than a distance between the first coordinate and the third coordinate.

In one aspect, the projecting step comprises moving the movable element through the intended pattern at a slow speed. In another aspect, the projecting step comprises moving the movable element at a constant speed. In another aspect, the projecting step comprises moving the movable element in a plurality of different acceleration states.

In some aspects, the movable element comprises a movable mirror.

In another aspect, the step of generating correction factors comprises generating correction factors due to displacement state errors.

In one aspect, the step of generating correction factors comprises generating correction factors due to speed state errors.

In some aspects, the step of generating correction factors comprises generating correction factors due to acceleration state errors.

A microscope system is provided, comprising: a stage; a sample disposed on the stage; an imaging subsystem adapted to obtain an image of the sample; a processing subsystem adapted to identify regions of interest in the sample from images obtained by the imaging subsystem; and a pattern illumination subsystem adapted to illuminate the regions of interest based on coordinates derived from the images by the processing subsystem, the pattern illumination subsystem being configured to: project light in an intended pattern according to a plurality of coordinates corresponding to locations on the sample; measure differences between coordinates of locations where the light strikes the sample and coordinates of the intended pattern; and generate correction factors based on the measured differences.

In some aspects, the sample comprises a fluorescent sample. In another aspect, the sample comprises a reflective sample. In one aspect, the sample is configured to be photo-marked.

In one aspect, the processing subsystem is configured to measure differences by observing the sample with the imaging subsystem while the pattern illumination subsystem projects light on the sample.

In one aspect, the system includes memory configured to store the correction factors.

In some aspects, the pattern illumination subsystem is configured to use the correction factors to adjust a position of light projected by the pattern illumination subsystem for calibrating the projected light in real-time in various fields of view. In another aspect, the pattern illumination subsystem comprises a movable element. In some aspects, the pattern illumination subsystem is configured to use the correction factors to adjust a position of light projected by the pattern illumination subsystem by controlling movement of the movable element.

In another aspect, the pattern illumination subsystem is configured to project light in the intended pattern by controlling movement of the movable element to project light from the pattern illumination system sequentially from a first coordinate to a second coordinate and from the first coordinate to a third coordinate, a distance between the first coordinate and the second coordinate being different than a distance between the first coordinate and the third coordinate.

In some aspects, the pattern illumination subsystem is configured to project light in the intended pattern by controlling movement of the movable element through the intended pattern at a slow speed.

In another aspect, the pattern illumination subsystem is configured to project light in the intended pattern by controlling movement of the movable element at a constant speed.

In some aspects, the pattern illumination subsystem is configured to project light in the intended pattern by controlling movement of the movable element in a plurality of different acceleration states.

In other aspects, the movable element comprises a movable mirror.

In some aspects, the pattern illumination subsystem is configured generate correction factors due to displacement state errors.

In another aspect, the pattern illumination subsystem is configured generate correction factors due to speed state errors.

In some aspects, the pattern illumination subsystem is configured generate correction factors due to acceleration state errors.

A non-transitory computing device readable medium having instructions stored thereon, wherein the instructions are executable by one or more processors to cause a computing device to perform a method comprising: measuring differences between coordinates of locations where projected light from a pattern illumination subsystem strikes a microscope sample and coordinates of an intended pattern; and generating correction factors based on the measured differences.

In one aspect, the sample is a fluorescent sample. In another aspect, the sample is a reflective sample. In some aspects, the sample is photo-marked.

In one aspect, the step of measuring differences comprises observing the microscope sample with an imaging subsystem while the pattern illumination subsystem projects light on the microscope sample.

In another aspect, the instructions are executable by the one or more processors to use the correction factors to adjust a position of light projected by the pattern illumination subsystem for calibrating the projected light in real-time in various fields of view.

In some aspects, the instructions are executable by the one or more processors to use the correction factors to adjust a position of light projected by the pattern illumination subsystem by controlling movement of a movable element.

In one aspect, controlling movement of the moveable element comprises moving the movable element to project light from the pattern illumination system sequentially from a first coordinate to a second coordinate and from the first coordinate to a third coordinate, a distance between the first coordinate and the second coordinate being different than a distance between the first coordinate and the third coordinate.

In another aspect, controlling movement of the movable element comprises moving the movable element through the intended pattern at a slow speed.

In another aspect, controlling movement of the moveable element comprises moving the movable element at a constant speed.

In some aspects, controlling movement of the moveable element comprises moving the movable element in a plurality of different acceleration states.

In another aspect, the step of generating correction factors comprises generating correction factors due to displacement state errors.

In some aspects, the step of generating correction factors comprises generating correction factors due to speed state errors.

In other aspects, the step of generating correction factors comprises generating correction factors due to acceleration state errors.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 shows one embodiment of a microscope-based system for image-guided microscopic illumination.

FIGS. 2A and 2B show light from a pattern illumination subsystem moving through regions of interest in a vector pattern and a raster pattern, respectively.

FIG. 3A shows a pattern illumination subsystem using calibration coordinates corresponding to an intended grid pattern on a sample.

FIG. 3B shows a captured image showing where light from the pattern illumination subsystem struck the sample.

FIG. 3C shows a comparison of the intended illumination locations with the actual illumination locations.

FIG. 3D shows application of the correction factors to align the actual illumination locations with the intended illumination locations.

FIG. 4 illustrates how calibration between image coordinates can take into account kinetic errors introduced by different movements within the illumination subsystem.

FIGS. 5A-5I illustrate hypothetical examples pursuant to an embodiment of the calibration methods of this disclosure.

### DETAILED DESCRIPTION

US Patent Publ. No. 2018/0367717 describes multiple embodiments of a microscope-based system for image-guided microscopic illumination. In each embodiment, the system employs an imaging subsystem to illuminate and acquire an image of a sample on a slide, a processing module to identify the coordinates of regions of interest in the sample, and a pattern illumination subsystem to use the identified coordinates to illuminate the regions of interest using, e.g., two-photon illumination to photoactivate the regions of interest. Any misalignment between the imaging subsystem and the pattern illumination subsystem may result in a failure to successfully photoactivate the regions of interest. In addition, any optical aberrations in either system must be identified and corrected for.

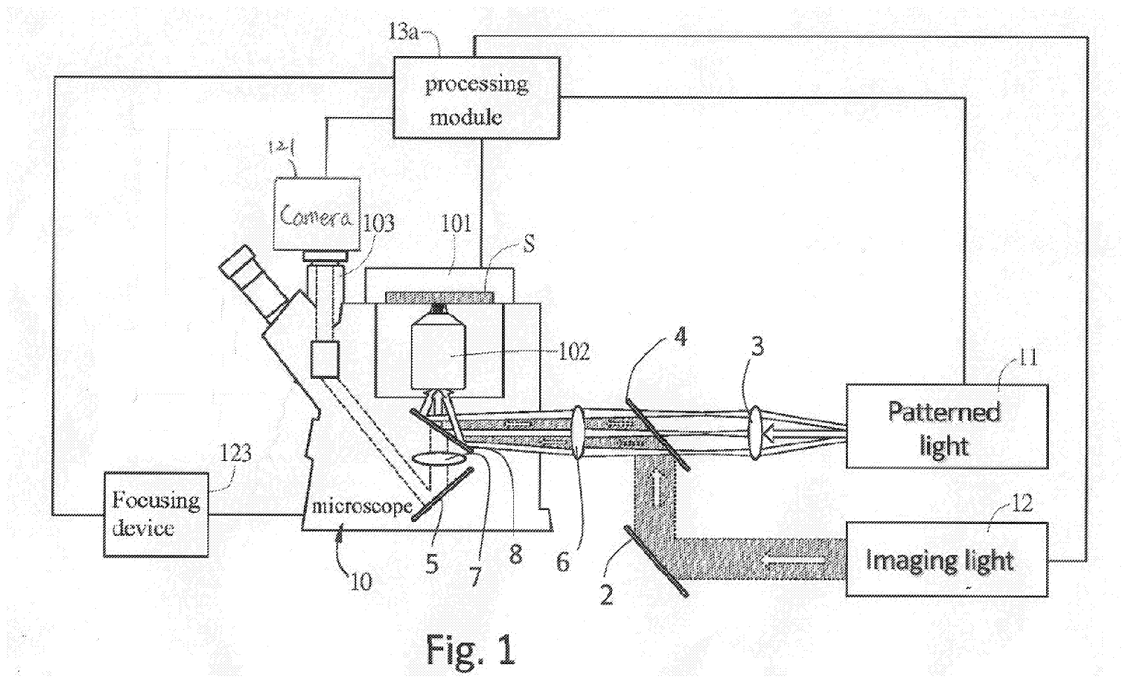

This disclosure provides a calibration method for a microscope-based system having two sample illumination subsystems, one for capturing images of the sample in multiple fields of view and another for illuminating regions of interest in each field of view that were automatically identified in the images based on predefined criteria. FIG. 1 shows one embodiment of a microscope-based system for image-guided microscopic illumination. Other details may be found in US Publ. No. 2018/0367717. A microscope 10 has an objective 102, a subjective 103, and a stage 101 loaded with a calibration sample S. An imaging subsystem 12 can illuminate the sample S via mirror 2, mirror 4, lens 6, mirror 8, and objective 102. An image of the sample S is transmitted to a camera 121 via mirror 8, lens 7, and mirror 5. The stage 101 can be moved to provide different fields of view of the sample S. The calibration sample S may comprise, for example, a fluorescent sample, a reflective sample, or a sample that can be marked by the light projecting from the imaging subsystem. For example, the sample mark can be bleached, activated, physically damaged, or chemically converted. The mark can be analyzed by the imaging subsystem, and the position of the mark may be represented by the result of the projected light.

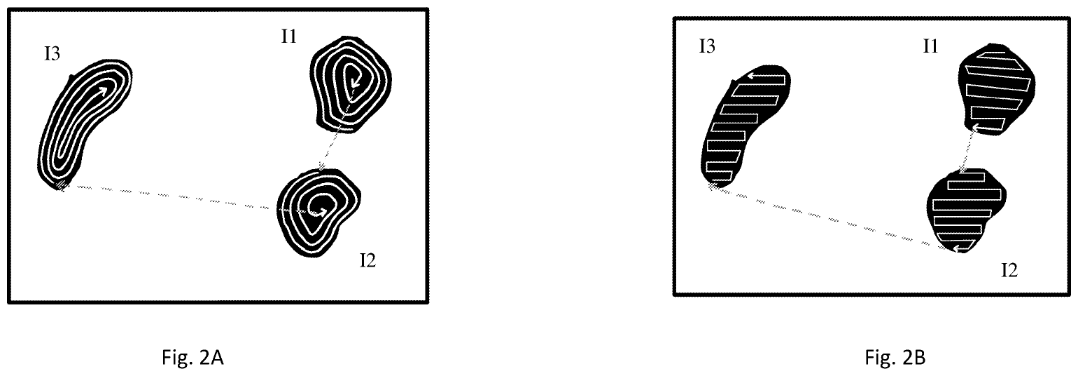

In some embodiments, as described in US Publ. No. 2018/0367717, images obtained by camera 121 can be processed in a processing subsystem 13a to identify regions of interest in the sample. For example, when the sample contains cells, particular subcellular areas of interest can be identified by their morphology. In some embodiments, the regions of interest identified by the processing module from the images can thereafter be selectively illuminated with a different light source for, e.g., photobleaching of molecules at certain subcellular areas, photoactivation of fluorophores at a confined location, optogenetics, light-triggered release of reactive oxygen species within a designated organelle, or photoinduced labeling of biomolecules in a defined structure feature of a cell all require pattern illumination. The coordinates of the regions of interest identified by the processing subsystem 13a create a pattern for such selective illumination. The embodiment of FIG. 1 therefore has a pattern illumination subsystem 11 which projects light onto sample S through a lens 3, mirror 4, lens 6, and mirror 8. In some embodiments, pattern illumination subsystem 11 employs a laser to illuminate through the pattern of the region of interest in the sample S by moving mirror within the pattern illumination subsystem 11. In some embodiments the light from pattern illumination subsystem 11 moves sequentially through the regions of interest 11, 12, 13, in a vector pattern, as shown in FIG. 2A, and in some embodiments the light from pattern illumination subsystem 11 moves through the regions of interest I1, 12, and I3 in a raster pattern, as shown in FIG. 2B.

The microscope, stage, imaging subsystem, and/or processing subsystem can include one or more processors configured to control and coordinate operation of the overall system described and illustrated herein. In some embodiments, a single processor can control operation of the entire system. In other embodiments, each subsystem may include one or more processors. The system can also include hardware such as memory to store, retrieve, and process data captured by the system. Optionally, the memory may be accessed remotely, such as via the cloud. In some embodiments, the methods or techniques described herein can be computer implemented methods. For example, the systems disclosed herein may include a non-transitory computing device readable medium having instructions stored thereon, wherein the instructions are executable by one or more processors to cause a computing device to perform any of methods described herein.

In order for the pattern illumination to illuminate the desired regions of interest, the coordinates identified from the image must result in illumination in a pattern that aligns with the coordinates. In order to address misalignment of the imaging and pattern illumination structure and any aberrations introduced by movement of the optical components and mirrors in the light path, a calibration process may be performed before actual use of the system and possibly periodically thereafter.

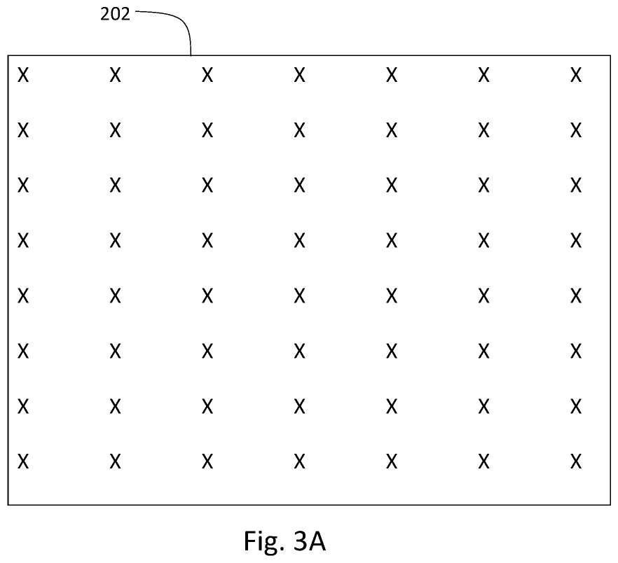

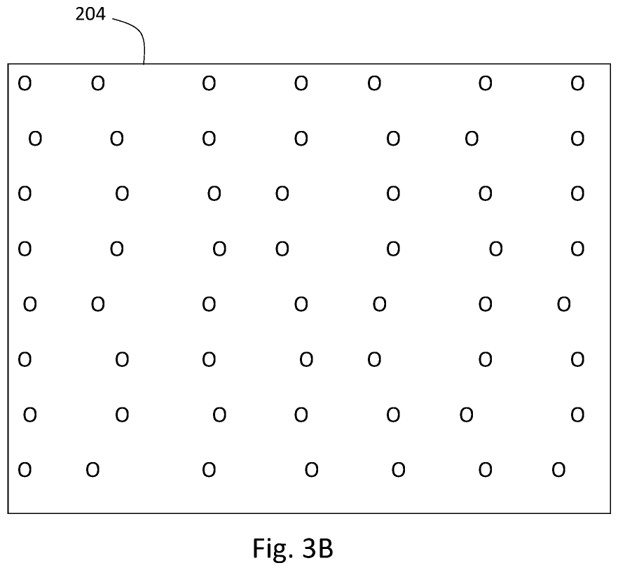

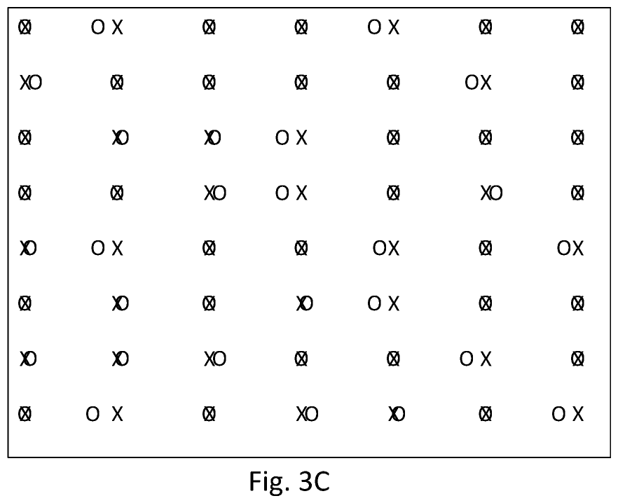

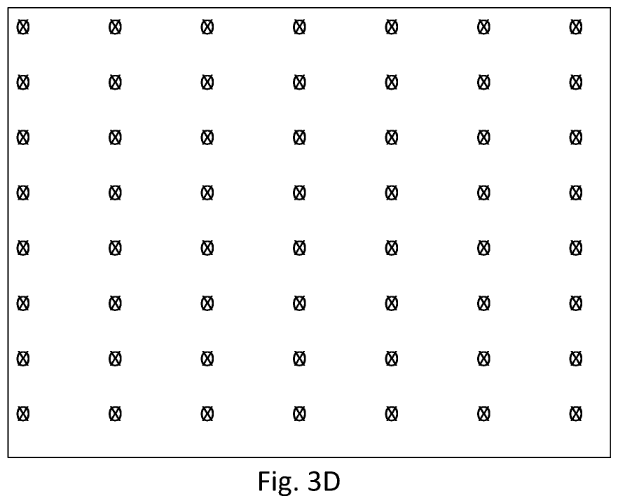

In one embodiment of the calibration process, a calibration sample S is placed on the stage 101. The pattern illumination subsystem 11 uses calibration coordinates “X” corresponding to an intended grid pattern 202 shown in FIG. 3A to illuminate calibration sample S. The resulting image 204 of the points (shown as “O” in FIG. 3B) is captured by camera 121 and shows where light from the pattern illumination subsystem actually struck sample S. For example, the image 204 of the points could show fluorescence, light reflection, marking, photo-marking, bleaching, activation, physical damage, or chemical conversion within the actual illuminated pattern. FIG. 3C shows a comparison of the intended illumination locations with the actual illumination locations. As shown, there are a number of illuminated grid points O that are not in the intended grid locations X. The system uses differences between the intended and actual illumination locations to automatically generate a set of correction factors for each illuminated point in the pattern. The correction factors can be stored (e.g., on local or cloud memory) for use during imaging and pattern illumination of an actual sample on the stage 101 to e.g., adjust movement of a mirror within the illumination subsystem 11 during pattern illumination of regions of interest in a sample. FIG. 3D shows application of the correction factors to align the actual illumination locations with the intended illumination locations.

In some embodiments, the processing subsystem 13a could generate a computed pattern including plural coordinates for illumination by the pattern illumination subsystem 11 as the intended pattern. In other embodiments, the processing system 13a could retrieve a pattern previously stored in system memory for illumination as the intended pattern. In yet other embodiments, the processing subsystem 13a could receive and project a given pattern from an outside source for illumination as the intended pattern. Based on the intended pattern, the pattern illumination subsystem 11, controlled by the processing subsystem 13a, projects light onto sample S, and the actual illuminated coordinates are real-time recorded by the camera 121. The processing subsystem 13a then compares the coordinates of the intended pattern with the illuminated coordinates. The resulting differences between the intended pattern coordinates and the actual illumination coordinates are converted to correction factors. In a certain embodiment, no calibration is performed unless the correction factors exceed a calibration threshold. After calibration, the coordinate difference between the intended pattern and the actual illumination pattern could be eliminated or reduced toward a status in which the correction factors are under the calibration threshold.

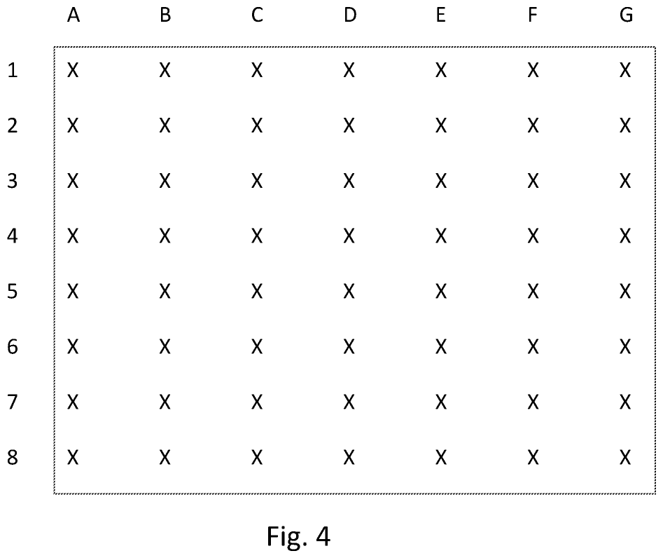

In some embodiments, calibration between the image coordinates, which are derived from the computed pattern and pattern illumination coordinates takes into account kinetic errors introduced by different movements of the mirror within the illumination subsystem 11. For example, a small movement between, e.g., point 1A in FIG. 4 to point 2B might introduce a smaller error than a larger movement from point 1A to point 6E. The calibration process according to such embodiments therefore tests movement of the pattern illumination light from one point on the calibration sample to many other (and optionally all other) test points on the calibration sample. The system then generates correction factors for movement of the pattern illumination light between selected points in the grid. In embodiments in which errors introduced by movement of the pattern illumination light between each point and each other point are not measure, the system may extrapolate correction factors determined between other measured pairs of points. The correction factors are stored for use during imaging and pattern illumination of an actual sample on the stage 101 to calibrate the illumination subsystem 11 during pattern illumination of regions of interest in a sample for precisely illuminating various patterns in any field of view on the sample.

In some embodiments, a pattern illumination movement from point 1A in FIG. 4 to point 2B could be predetermined based on a dynamic model:

$${G}_{1} {Mq}^{″} ( t ) + {G}_{2} {Cq}^{′} ( t ) + {G}_{3} Kq ( t ) = Gf ( t ) ,$$

wherein M is a systemic inertia matrix; q″(t) is an acceleration state; G₁ is a geometric vector of the systemic inertia matrix; C is a systemic damping coefficient matrix; q′(t) is a speed state; G₂ is a geometric vector of the systemic damping coefficient matrix; K is a systemic stiffness matrix; q(t) is displacement state; G₃ is a geometric vector of the systemic stiffness matrix; f(t) is an external moment of force; G is a total geometric vector of the external moment of force, which allowed movements of the mirror for pattern illumination so as to complete the movement from point 1A to point 2B, wherein the direction from point 1A to point 2B was related to G.

When the pattern illumination subsystem 11 performs the predetermined pattern illumination movement from point 1A to point 2B, the movement is real-time recorded by the camera 121. The real-time movement might be different from the predetermined movement based on the dynamic model, and the difference therebetween might be due to the real-time acceleration state, the real-time speed state, the real-time displacement state, the shift of the geometric vector and a combination of two, three, or all of the previous factors. All of these parameters can be determined from the actual movement of the illumination through the pattern as recorded by the camera. Based on the real-time movement, a real-time model could be established as shown below:

$${G}_{1} {Mq}^{″} ( t ) + {G}_{2} {Cq}^{′} ( t ) + {G}_{3} Kq ( t ) = Gf ( t ) + {G}_{4} □ f ( t ) ,$$

wherein □f(t) is a total moment of interferential force and G₄ is a geometric vector of the moment of interferential force. The more real-time image or data that is collected, the more known factors can be used to calculate G₄ or If(t). Once the values of G₄ and f(t) are solved, meanwhile, the values of G₁ to G₃, Mq″(t), Cq′(t) and Kq(t) could be solved so as to identify the reason(s) for the difference between the real-time movement and the predetermined movement.

The values of G₄ and □f(t) are recorded and converted to correction factors by the processing subsystem 13a. In some embodiments, once the correction factors exceed a predetermined threshold, a calibration is performed to eliminate or reduce the values of G₄ and f(t) toward a status in which the correction factors are under the predetermined threshold. The calibration process uses the correction factors to modify movement of the illumination (e.g., movement of movable mirror in the pattern illumination assembly 11 of FIG. 1) through the intended illumination pattern to reduce the values of G₄ and □f(t). In some embodiments, the calibration process uses the correction factors to modify movement of the illumination through adjusting related driven parameters (e.g., delay time, dwell time, speed, acceleration of the movement.) In this embodiment, G₁ to G₄ and G are in two dimensions, e.g., G₁ could be (Gx₁, Gy₁). In some embodiments, G₁ to G₄ and G are in three dimensions, e.g., G₁ could be (Gx₁, Gy₁, Gz1).

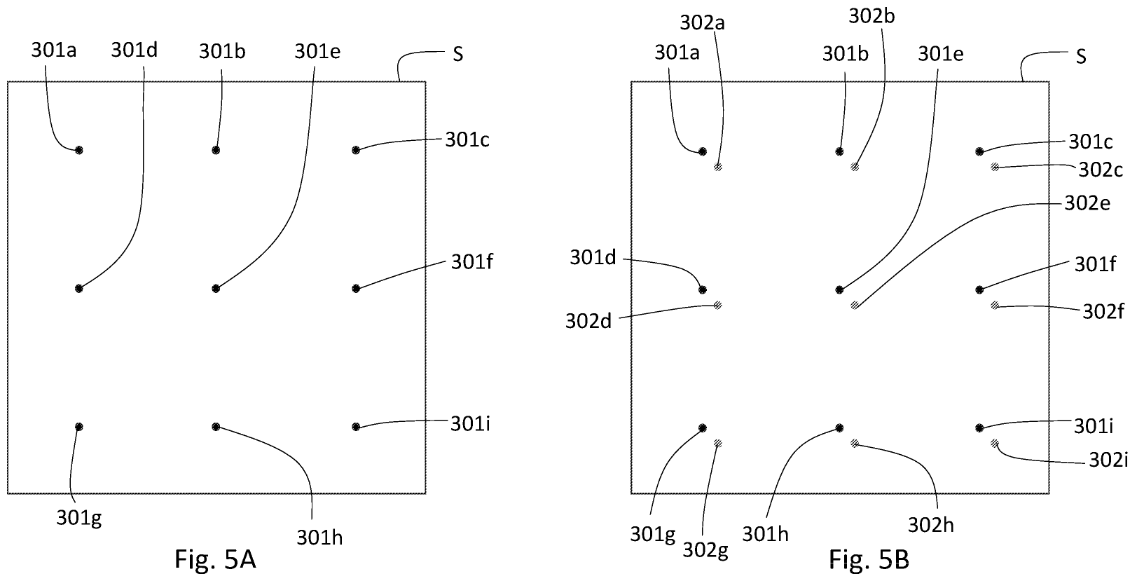

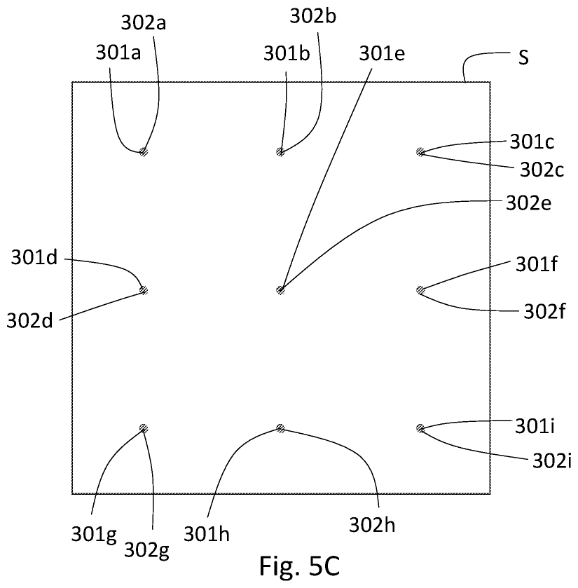

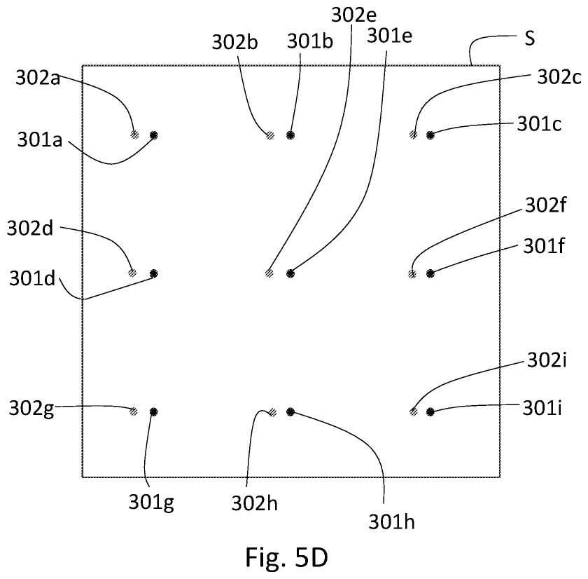

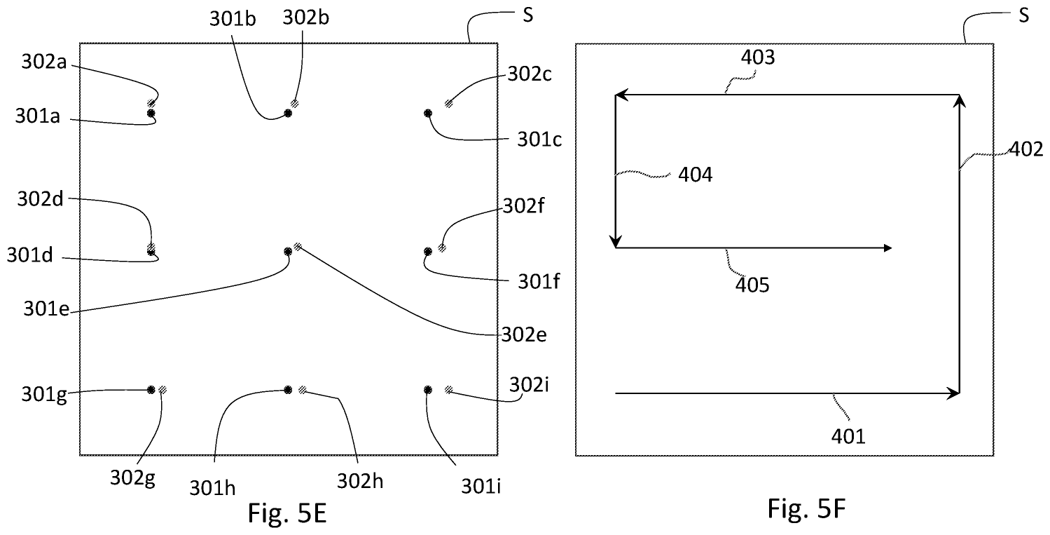

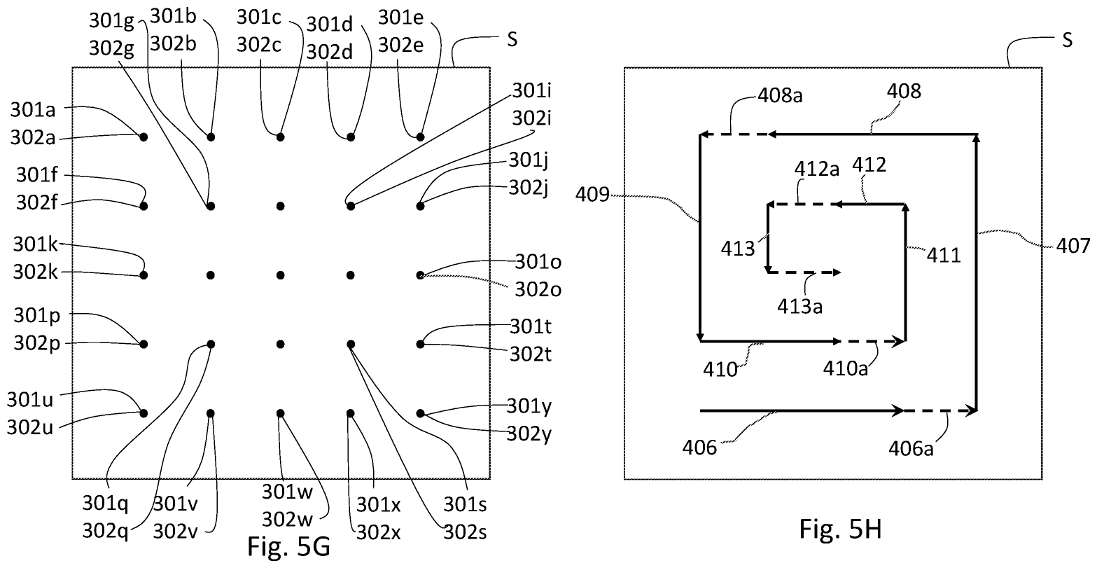

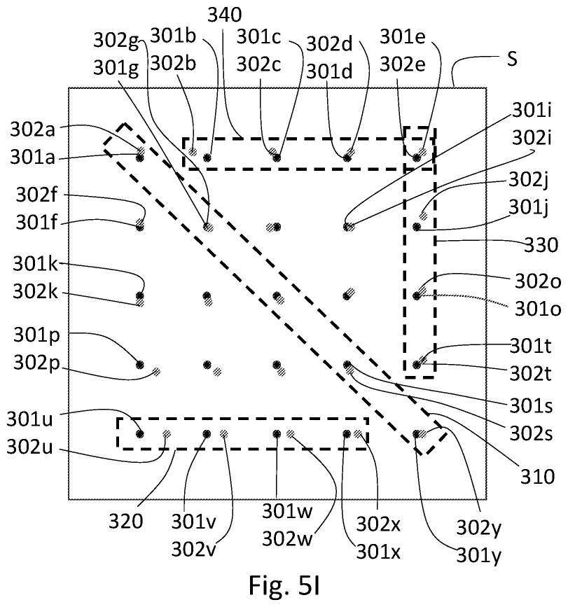

FIGS. 5A-5C illustrate a hypothetical example pursuant to an embodiment of the calibration methods of this disclosure. In this example, the intended pattern is a given pattern that includes nine spots 301a-301i intended to be illuminated by the system for purposes of a calibration process. The processing subsystem 13a controls the pattern illumination subsystem 11 to project light onto a calibration sample S according to intended coordinates of those spots 301a-301i. In this case, the pattern illumination subsystem 11 is set to illuminate sample S with the intended pattern in a very slow motion so that any interferences from the speed and acceleration states can be ignored, leaving the displacement state as the reason for any differences between the intended pattern and the actual illumination pattern. If the system components are correctly calibrated, the spots 302a-302i of the actual illuminated pattern should totally overlap the intended spots 301a-301i when detected by the system camera, as shown in FIG. 5C. When the coordinates of spots 302a-302i, where the light from pattern illumination subsystem 11 is actually projected, are recorded by the system camera as shown in FIG. 5B, the system detects the coordinate difference between the actual illuminated spots 302 and the intended spots 301 of the intended pattern. Because there is no interference from the acceleration state and the speed state, the values of G₁Mq″(t) and G₂Cq′(t) between the real-time model and the dynamic model should be the same; G₄□f(t) is therefore equal to the difference of G₃Kq(t) between two models. The coordinate difference between the actual light movement and the intended light movement is due solely to the difference of the two displacement states, which is converted to correction factors. After the displacement calibration is performed, when repeating the slow motion pattern illumination to minimize any speed or acceleration effects, the actual illuminated spots 302 and the intended spots 301 will be as shown in FIG. 5C because the value of G₄□f(t) (in this case, the difference of G₃Kq(t) between two models) has been reduced to zero.

FIGS. 5A, 5C and 5D illustrate another hypothetical example pursuant to an embodiment of the calibration methods of this disclosure. As in the prior example, the intended pattern is a given pattern that includes nine spots 301a-301i intended to be illuminated by the system for purposes of a calibration process, as shown in FIG. 5A. This example assumes that a displacement calibration, such as the displacement calibration described above, has been performed and the previously-mentioned difference of G₃Kq(t) has been eliminated or reduced. In this example, the pattern illumination subsystem illuminates sample S while moving at a constant speed, e.g., by moving the pattern illuminating subsystem's mirror at a constant speed to illuminate coordinates of intended points 301g, 301d, and 301a, then moving the mirror at a constant speed to illuminate coordinates of the intended points 301h, 301e, and 301b, then moving the mirror at a constant speed to illuminate coordinates of the intended points 301i, 301f, and 301c. If the system is correctly calibrated and there are no speed state errors, the actual illuminated spots 302a-302i detected by the system camera should totally cover the intended spots 301a-301i, as shown in FIG. 5C. If, however, there are speed state errors, the spots 302a-302i on sample S may be illuminated at spots 302a-302i whose coordinates differ from the coordinates of the intended illumination pattern 301a-301i, as shown in FIG. 5D. The differences between the coordinates of the intended illumination spots 301a-301i and the coordinates of the actual illumination spots 302a-302i are assumed to be due to the speed state. Because there is no interference from the acceleration state (because of the constant speed of the pattern illumination), and because the displacement state is assumed be zero due to a prior displacement state calibration, the values of G₁Mq″(t) and G₃Kq(t) between real-time model and the dynamic model should be the same. G₄ □□f(t) is therefore equal to the difference of G₂Cq′(t). These coordinate differences are converted to correction factors for use in a speed state calibration of the system. After the displacement and speed state calibrations have been performed using the correction factors, and assuming movement at a constant speed during pattern illumination to eliminate acceleration effects, the coordinates of the illuminated spots 302a-302i and the coordinates of the intended spots 301a-301i will be located as shown in FIG. 5C, and the difference of G₂Cq′(t) or G₄□f(t) is eliminated.

FIGS. 5E and 5F illustrate yet another hypothetical example pursuant to an embodiment of the calibration methods of this disclosure. As in the prior examples, the intended pattern is a given pattern that includes nine spots 301a-301i intended to be illuminated by the system for purposes of a calibration process, as shown in FIG. 5A. This example assumes that a displacement calibration and a speed state calibration, such as those described above, have been performed, so that the displacement factor G₃Kq(t) and the speed factor G₂Cq′(t) or G₄ □f(t) have both been reduced to zero.

In this example, after the displacement and the speed state differences are calibrated, the pattern illumination subsystem illuminates sample S while moving among the intended illumination points according to sequential force vectors 401, 402, 403, 404 and 405, as shown in FIG. 5F, which have different acceleration states. Force vector 401 and force vector 405 are in same direction. Force vector 403 and force vector 405 are in opposite directions, while force vector 401 and force vector 402 are perpendicular to each other. Theoretically, although the force vectors 401, 402, 403, 404 and 405 lead to acceleration states in various directions, the actually illuminated spots 302a-302i should align with the intended spots 301a-301i, as shown in FIG. 5C. However, errors caused by the acceleration of the moving component(s) of the pattern illumination system (e.g., the mirror) may cause a difference between the intended points 301a-301i and the actual illuminated points 302a-302i, as shown in FIG. 5E, even without any displacement and speed interference. Because there is no interference from the speed state and the displacement state, the values of G₂Cq′(t) and G₃Kq(t) between the real-time model and the dynamic model should be the same; G₄□f(t) is therefore equal to the difference of G₁Mq″(t). These coordinate differences are converted to correction factors for use in an acceleration state calibration of the system. After the displacement, speed, and acceleration calibrations have been performed, the coordinates of the illuminated spots 302a-302i line up with the coordinates of the intended spots 301a-301i, as shown in FIG. 5C.

In the previous examples as shown in FIGS. 5A to 5F, the coordinate differences of the displacement state, speed state, and acceleration state are calibrated sequentially and separately. While the same intended pattern was used for each of those calibrations in the examples above, the intended pattern used for each of these calibrations could be different, and the illuminating path for the pattern could be the same or different.

In the above examples, the system can measure the difference or displacement between the intended illumination spots or pattern and the actual illuminated spots or pattern. To provide a calibration based on speed or acceleration, the system can optionally measure or calculate speed and/or acceleration. In one example, the system can calculate speed by dividing the displacement by the time difference (delta t). Similarly, acceleration can be calculated by subtracting the speed at a first point or location from the speed at a second point or location and then dividing the speed differential by the time difference (delta t). Therefore, in any of the calibration steps described herein in which speed or acceleration are needed for the calibration, the speed and/or acceleration can be directly measured, or alternatively, can be calculated as described above.

In some embodiments, multiple different fields of view may be used to sequentially perform the calibrations for the displacement state, speed state, and acceleration state. The intended patterns among some of these fields of view could be the same or different, and the illuminating paths for the pattern could be the same or different.

In still another hypothetical example, as shown in FIGS. 5G-5I, the intended pattern is a given pattern that includes twenty-five spots 301a-301y intended to be illuminated by the system for purposes of a calibration process. According to the coordinates of the spots 301a-301y of the given pattern, the processing subsystem 13a controls the pattern illumination subsystem 11 to illuminate a calibration sample S while moving among the intended illumination points according to sequential force vectors 406, 407, 408, 409, 410, 411, 412, and 413, as shown in FIG. 5H. The dotted lines 406a, 408a, 410a, 412a, and 413a extending from some of the sequential force vectors indicate that nearly no net force is applied for that portion of the illumination shift, i.e., the pattern illumination subsystem moves very slowly through those segments to eliminate speed or acceleration errors, so that any errors identified in those movement segments can be attributed to the displacement state. If there are no acceleration, speed, or displacement state errors, the illuminated spots 302a-302y should totally overlap the intended spots 301a-301y, as shown in FIG. 5G. (Element numbers and lead lines for spots 301h, 302h, 301l, 302l, 301m, 302m, 301n, 302n, 301r, and 302r are omitted from FIG. 5G for clarity.)

In this example, however, errors may cause the coordinates of some or all of the spots 302a-302y actually illuminated by the pattern illumination subsystem 11 to differ from the coordinates of intended spots 301a-301y, as shown in FIG. 5I. Spots 302y, 302a, 302s, 302g, and 302m illuminated at the end of slow speed segments 406a, 408a, 410a, 412a, and 413a shown in FIG. 5H, i.e., the illuminated spots within the region 310 shown in FIG. 5I, are under nearly no net force; the spots 302y, 302a, 302s, 302g, and 302m within the region 310 are therefore not affected by the acceleration state and the speed state. Thus, the differences between the coordinates of the actually illuminated spots 302y, 302a, 302s, 302g, and 302m within region 310 and the intended spots 301y, 301a, 301s, 301g, and 301m can be used to calibrate the coordinate difference due to the difference of the two displacement states. The displacement difference is converted to correction factors for use in calibration of the system. Likewise, coordinate differences between the illuminated spots 302 and the intended spots 301 within the regions 320, 330 and 340 could be used to calculate the differences of G₂Cq′(t) (speed state), G₁Mq″(t) (acceleration state) and a combination thereof, and those differences are converted to correction factors for use in calibration of the system. Thus, in this embodiment, a single field of view may be used to calibrate the differences due to the displacement state, speed state, acceleration state or a combination of two or three states thereof.

In some embodiments, those correction factors could be used to fit in certain equation for figure out the parameter to adjust the dynamic states including displacement, speed or acceleration states for individual or total calibration.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

A complete listing of the claims follows:

1. A method of calibrating a microscope system, the microscope system comprising a stage, an imaging subsystem adapted to obtain an image of a sample on the stage, a processing subsystem adapted to identify regions of interest in the sample from images obtained by the imaging subsystem, and a pattern illumination subsystem adapted to illuminate the regions of interest based on coordinates derived from the images by the processing subsystem, the method comprising:
projecting light from the pattern illumination subsystem in an intended pattern according to a plurality of coordinates corresponding to locations on the sample;
measuring differences between coordinates of locations where the light strikes the sample and coordinates of the intended pattern; and
generating correction factors based on the measured differences.

2. The method of claim 1, wherein the sample is one of a fluorescent sample, a reflective sample, and a sample able to be photo-marked.

3-6. (canceled)

7. The method of claim 1, further comprising using the correction factors to adjust a position of light projected by the pattern illumination subsystem for calibrating the projected light.

8. The method of claim 7, wherein the pattern illumination subsystem comprises a movable mirror, wherein using the correction factors to adjust the position of light further comprises adjusting movement of the moveable mirror.

9. (canceled)

10. The method of claim 8, wherein the projecting step comprising moving the movable mirror to project light from the pattern illumination system sequentially from a first coordinate to a second coordinate and from the first coordinate to a third coordinate, a distance between the first coordinate and the second coordinate being different than a distance between the first coordinate and the third coordinate.

11. The method of claim 8, wherein the projecting step comprises moving the movable mirror through the intended pattern at a slow speed, at a constant speed, or in a plurality of different acceleration states.

12-14. (canceled)

15. The method of claim 1, wherein the step of generating correction factors comprises generating correction factors due to displacement state errors, due to speed state errors, or due to acceleration state errors.

16-17. (canceled)

18. A microscope system, comprising:
a stage;
a sample disposed on the stage;
an imaging subsystem adapted to obtain an image of the sample;
a processing subsystem adapted to identify regions of interest in the sample from images obtained by the imaging subsystem; and
a pattern illumination subsystem adapted to illuminate the regions of interest based on coordinates derived from the images by the processing subsystem, the pattern illumination subsystem being configured to:
project light in an intended pattern according to a plurality of coordinates corresponding to locations on the sample;
measure differences between coordinates of locations where the light strikes the sample and coordinates of the intended pattern; and
generate correction factors based on the measured differences.

19. The microscope system of claim 18, wherein the sample comprises a fluorescent sample, a reflective sample, and a sample able to be photo-marked.

20-23. (canceled)

24. The microscope system of claim 18, wherein the pattern illumination subsystem is configured to use the correction factors to adjust a position of light projected by the pattern illumination subsystem for calibrating the projected light.

25. The microscope system of claim 18, wherein the pattern illumination subsystem comprises a movable mirror, and wherein the pattern illumination subsystem is configured to use the correction factors to adjust a position of light projected by the pattern illumination subsystem by controlling movement of the movable element.

26. (canceled)

27. The microscope system of claim 25, wherein the pattern illumination subsystem is configured to project light in the intended pattern by controlling movement of the movable mirror to project light from the pattern illumination system sequentially from a first coordinate to a second coordinate and from the first coordinate to a third coordinate, a distance between the first coordinate and the second coordinate being different than a distance between the first coordinate and the third coordinate.

28. The microscope system of claim 25, wherein the pattern illumination subsystem is configured to project light in the intended pattern by controlling movement of the movable element through the intended pattern at a slow speed, at a constant speed, or in a plurality of different acceleration states.

29-31. (canceled)

32. The microscope system of claim 18, wherein the pattern illumination subsystem is configured generate correction factors due to displacement state errors, due to speed state errors, or due to acceleration state errors.

33-34. (canceled)

35. A non-transitory computing device readable medium having instructions stored thereon, wherein the instructions are executable by one or more processors to cause a computing device to perform a method comprising:
measuring differences between coordinates of locations where projected light from a pattern illumination subsystem strikes a microscope sample and coordinates of an intended pattern; and
generating correction factors based on the measured differences.

36. The non-transitory computing device readable medium of claim 35, wherein the sample is one of a fluorescent sample, a reflective sample, and a sample able to be photo-marked.

37-39. (canceled)

40. The non-transitory computing device readable medium of claim 35, wherein the instructions are executable by the one or more processors to use the correction factors to adjust a position of light projected by the pattern illumination subsystem for calibrating the projected light.

41. The non-transitory computing device readable medium of claim 35, wherein the instructions are executable by the one or more processors to use the correction factors to adjust a position of light projected by the pattern illumination subsystem by controlling movement of a movable mirror of the pattern illumination subsystem.

42. The non-transitory computing device readable medium of claim 41, wherein controlling movement of the moveable mirror comprises moving the movable mirror to project light from the pattern illumination system sequentially from a first coordinate to a second coordinate and from the first coordinate to a third coordinate, a distance between the first coordinate and the second coordinate being different than a distance between the first coordinate and the third coordinate.

43. The non-transitory computing device readable medium of claim 41, wherein controlling movement of the moveable mirror comprises moving the movable mirror through the intended pattern at a slow speed, at a constant speed, or in a plurality of different acceleration states.

44-45. (canceled)

46. The non-transitory computing device readable medium of claim 35, wherein the step of generating correction factors comprises generating correction factors due to displacement state errors, due to speed state errors, or due to acceleration state errors.

47-48. (canceled)
